(19) United States
(12) Patent Application Publication
(10) Pub. No.: US 2008/0169294 A1
(43) Pub. Date: Jul. 17, 2008

(54) Steam-Table Pan

(76) Inventor: Mark Liebzeit, Fond du Lac, WI (US)

Correspondence Address: Peter N. Jansson;Jansson Shupe & Munger Ltd., 245 Main Street, Racine, WI, 53403, US

(21) Appl. No.: 11/760,572

(22) Filed: Jun. 8, 2007

Related U.S. Application Data
(63) Continuation of application No. 11/623,557, filed on Jan. 16, 2007, now abandoned.

(51) Int. Cl. A47J 27/04

(52) U.S. Cl. 220/573.1

(57) ABSTRACT

A steam-table pan having a pinch-gripping bead including a gripping-skirt which is configured and vertically dimensioned for pinch-gripping of the bead with an adult's fingers to raise the pan from the steam-table.

### RELATED APPLICATION

This application is a continuation of patent application Ser. No. 11/623,557, filed Jan. 16, 2007, currently pending. The contents of the parent application are incorporated herein by reference.

### FIELD OF THE INVENTION

This invention relates to food pans, particularly to food pans for use in buffet and/or steam-tables (referred to collectively herein as “steam-tables”).

### BACKGROUND OF THE INVENTION

In the food service industry, foods are often served on buffet tables designed to maintain desired temperatures for cold or hot foods. The desired temperature maintenance is provided by cold air or hot steam (and/or cold or hot water) within the chamber of a steam-table. Such chamber, of course, is immediately beneath the top wall of the steam-table, and the top wall has openings to receive special food-serving pans such that the walls of the pan (sidewalls and bottom wall) are fully exposed to the chamber when the pan is in place on the steam-table.

Steam-table pans have a lip-portion protruding outwardly from the upper edges of the sidewalls, and when the pan is in position on the steam-table, it is supported by the engagement of its lip-portion with the top of the steam-table top wall. Thus, the food in the pan is kept at the desired temperature (or, more specifically, within a desired temperature range, by the fluid (air, steam and/or liquid water) in contact with the pan. Of course, it is important that the pan or pans on the steam-table sufficiently close the chamber to prevent undesired heat losses or gains. The “seal” between the pan and the table top is provided by the contact of the lip-portion of the pan with the top of the steam-table.

In use, steam-table pans need to be repeatedly removed from the steam-table for refilling, replacement, cleaning and other reasons. Steam-table pan configurations have made it difficult to remove the pans from steam-tables. Typically, lifting is accomplished by wedging a finger, utensil or other tool under the lip-portion to begin lifting the pan. Such actions may be rather dangerous to a person trying to lift the pan from the table since uncontrolled escape of steam may burn the person's hand. It is rather common practice for personal to attempt to facilitate this initial lifting step by intentionally and permanently deforming the lip-portion in one or more places to provide a gripping place or to facilitate a wedging step. Such lip deformation breaks the “seal” between the pan and the table top, which results in harmful heat losses or gains. This can greatly decrease steam-table efficiency by raising the use of power for maintaining the desired temperature, not to mention the fact that the appearance of the pan is ruined. There is a need for a steam-table pan which is easily removable from the steam-table and which, when the pan is in place, reliably closes the chamber to prevent energy inefficiency throughout the life of the pan.

These problems are so longstanding and commonplace that some inventive efforts have been made to deal with such problems. One of the existing solutions to the problem of raising a pan out of the steam-table involves a “ramping” configuration which involves a rather drastic change in pan geometry which allows a pushing or pulling action on the inside surface of a pan sidewall against the edge of a steam-table opening to cause some initial raising of the pan, thereby to facilitate lifting and removal.

Such “ramping” pans, which are understandably quite expensive, have a number of disadvantages stemming from their unusual configurations.

Among the problems are a resulting loss in pan capacity because of the more-inward nature of the configuration due to the ramping features. Also, the ramping configuration is such that it may increase the possibility of spilling pan contents due to the less-vertical nature of the pan sidewalls near the lip-portion. Furthermore, the non-standard shapes of such “ramping” pans mean that they are not readily stacked with users' existing inventories of steam-table pans of typical configurations. A further disadvantage of such “ramping” pans is that because of their non-typical configurations they typically require that accessories used with steam-table pans, such as wire grates, false bottoms and even some utensils, cannot be of standard shapes and sizes. For example, wire grates and false bottoms may have to be smaller than standard wire grates and false bottoms; and serving scoops may require unusual, non-standard shapes because scoops of standard round-edge shapes will not completely engage with bottom and side corners of the pans. The requirement of special accessories tends to significantly increase the total cost to an institution of using such “ramping” pans.

Still another problem is that the pushing or pulling action on the inside surfaces of such “ramping” pans typically involves manual contact with wall surfaces which are or have been exposed to food. This may raise concerns related to sanitation, whether or not personnel use gloves, and also creates finger/glove cleanliness issues. Also related to cleanliness is the fact that such “ramping” pans, with their significantly increased surface irregularities, are more difficult to wash. Wiping action on inside surfaces must give additional attention to such irregularities in order to avoid food residues from remaining after washing operations.

Thus, there is a need for a steam-table pan which provides easy removability from the steam-table without giving rise to aforementioned problems associated with pans having the aforementioned “ramping” features.

Another problem with certain steam-table pans of the prior art arises because such pans frequently moved around for different purposes in fast-moving institutional kitchen operations. Such movements and handling on many occasions can result in pans' dropping and receiving significant impact damage on their lip-portions. In addition, in kitchen storage areas various heavy objects may fall on steam-table pans causing deformation of the lip-portions. Any such deformations tend to be permanent, and cause the same problems as the intentional lip-portion distortions mentioned above. Pan deformation obviously limits useful pan life, giving rise to replacement costs. Thus, it is highly desirable to have long-lasting, sturdy pan construction. There is a need in the industry for steam-table pans with improved lip-portion strength.

In summary, there is a need for an improved steam-table pan which is easily liftable from steam-tables and which overcomes all of the aforementioned problems.

### OBJECTS OF THE INVENTION

It is an object of the invention to provide an improved steam-table pan overcoming some of the problems and shortcomings of the prior art, including those referred to above.

Another object of the invention is to provide a steam-table pan which is easily removable from the steam-table simply by hand gripping and lifting.

Another object of the invention is to provide a steam-table pan with such easy removal characteristic and which, when the pan is in place, reliably closes the chamber to prevent energy inefficiency throughout the life of the pan.

Yet another object of the invention is to provide a steam-table pan with improved lip-portion strength for long-lasting, sturdy pan construction.

Another object of the invention is to provide a steam-table pan which is designed for easy removability from the steam-table without sacrifice of pan capacity.

Another object of the invention is to provide a steam-table pan which is designed for easy removability from the steam-table without increased possibility of spillage.

Yet another object of the invention is to provide a steam-table pan which is designed for easy removability, yet allows use of accessories of typical sizes.

Another object of the invention is to provide a steam-table pan which is easily removable from the steam-table and can be readily stacked with users' existing inventories of pans.

Still another object of the invention is to provide a steam-table pan which is easily removable from the steam-table and minimizes pan-washing problems.

How these and other objects are accomplished will become apparent from the following descriptions and the drawings.

### SUMMARY OF THE INVENTION

This invention, which will be described in detail below, is an improvement in steam-table pan of the type including (a) a surrounding wall that is dimensioned for insertion in an opening in the top of a steam table and has an upper edge and (b) a lip-portion integral with the upper edge and protruding outwardly therefrom to overlap the steam-table top.

The inventive steam-table pan has a pinch-gripping bead which includes the normal upper portion of the surrounding wall, the lip-portion, and a gripping-skirt, now described. The gripping-skirt is integral with the lip-portion, extends downwardly from the lip-portion to rest on the steam-table top, and is configured and vertically dimensioned for pinch-gripping of the bead with an adult's fingers to raise the pan from the steam-table. The fact that the gripping-skirt is configured and vertically dimensioned for pinch-gripping of the bead with an adult's fingers to raise the pan from the steam-table means that it is such that an adult can pinch-grip the bead and lift the pan from its fully-engaged position on the steam-table. Pinch-gripping means firmly holding the inner surface of the upper portion of the surrounding wall and the gripping-skirt between his or her (1) thumb and (2) index and/or middle finger(s).

Preferably, the gripping-skirt is vertically dimensioned for its engagement by a mid-portion of an adult's thumb to raise the pan from the steam-table. Such vertical dimension of the gripping-skirt is preferably at least about ½ inch. Preferably, the gripping-skirt may be configured such that it extends vertically downwardly from the lip-portion by a distance greater than the lip-portion extends horizontally outwardly from the upper edge of the surrounding wall.

It is further preferred that the gripping-skirt be substantially parallel to the surrounding wall. The term “substantially parallel” as used herein does not require a true parallel relationship between the gripping-skirt and upper portion of the surrounding wall. However, it is preferable that they at least partially extend in the same direction resulting in substantially equidistant relationships of their horizontally-spaced planar portions to facilitate a secure grip of the pinch-gripping bead between an adult's fingers for pan-lifting purposes. In preferred embodiments of the invention, the gripping-skirt is substantially vertical.

An important aspect of the present invention is that the necessary substantial vertical dimension of the gripping-skirt also serves as vertical reinforcement of edge region of the pan. In the prior art, pan-edge distortion, particularly in corner areas, whether due to intentional bending or unintentional dropping or impact, was not readily resisted by the nature of the pan-edge area. However, corner areas of the pan of this invention are significantly resistant to distortion by virtue of the necessary substantial vertical dimension of the gripping-skirt around the corners.

The inventors and their associates commissioned impact/drop testing on the inventive steam-table pan. Two types of tests were performed, one involving load testing and the other involving impact/drop testing. The independent testing showed that edge areas (including corner areas) of the pan of this invention are approximately twice as strong as for certain prior pans. Such improved strength does not come by virtue of thicker metal, but by virtue of the edge features of this invention. This advantage, of course, can also mean acceptable distortion resistance even with some cost-saving reductions in material thickness.

The steam-table pan also includes a bottom-wall, bottom corners that are integral with the surrounding wall and the bottom-wall, such bottom-corners being shaped with common partial circular cross-sections. The surrounding wall includes the sidewalls and also side-corners which are integral with adjacent pairs of sidewalls, the side-corners being shaped with the common partial circular cross-sections just mentioned. Such common partial circular cross-sections facilitates full engagement of all corners by industry-standard circular-edged utensils.

The term “industry-standard circular-edged utensils” means utensils (e.g., serving spoons, loons, scoops or dishers) having scooping radii of commonly used existing utensils. For example, scooping radii for some common utensils of different capacities are 1.23 inches, 1.56 inches, 1.66 inches, 2.00 inches and 2.22 inches. The common partial circular cross-sections of the bottom-corners and side-corners are shaped to accommodate such utensils; no special utensils are needed for buyers/users of the inventive steam-table pans.

The steam-table pan of this invention overcomes the problems described above, and provides important advantages for institutional food operations.

### BRIEF DESCRIPTION OF THE DRAWINGS

FIG. 1 is a perspective view of a steam-table pan approximately two and a half inch deep having a pinch-gripping bead of this invention.

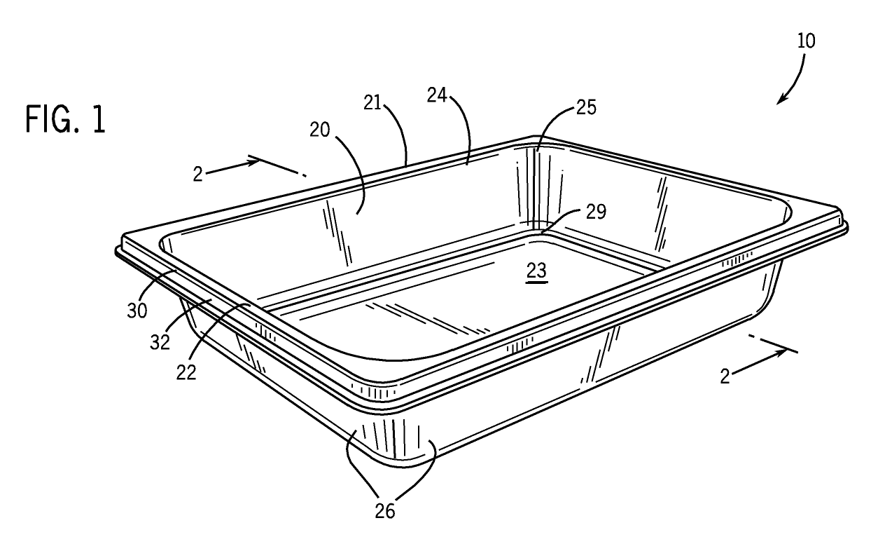

FIG. 2 is an enlarged fragmentary sectional view taken along section 2-2 as indicated in FIG. 1.

FIG. 3 is a sectional view like on FIG. 2 and showing pinch-gripping action by adult's fingers.

FIG. 4 is a perspective view of another embodiment of a steam-table pan.

### DETAILED DESCRIPTION OF PREFERRED EMBODIMENTS

The drawings show an improved steam-table pan 10 of the type including (a) a surrounding wall 20 that is dimensioned for insertion in an opening in the top 12 of a steam table and has an upper edge 21 and (b) a lip-portion 22 integral with upper edge 21 and protruding outwardly therefrom to overlap steam-table top 12.

Steam-table pan 10 has a pinch-gripping bead 30 which includes the normal upper portion 24 of surrounding wall 20, lip-portion 22, and a gripping-skirt 32. As seen in the figures, gripping-skirt 32 is integral with lip-portion 22, extends downwardly from lip-portion 22 to rest on steam-table top 12, and is configured and vertically dimensioned for pinch-gripping of bead 30 with an adult's fingers 14 to raise pan 10 from the steam-table.

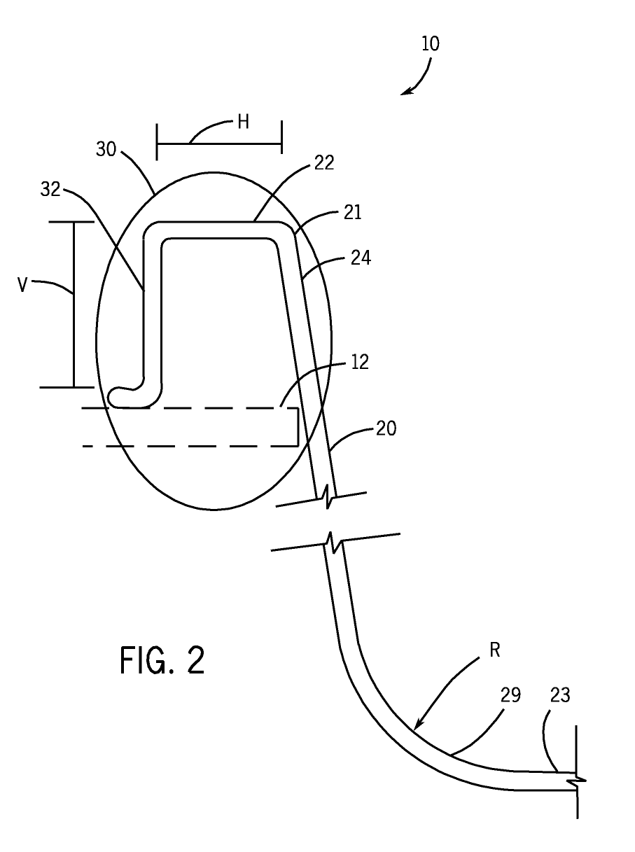

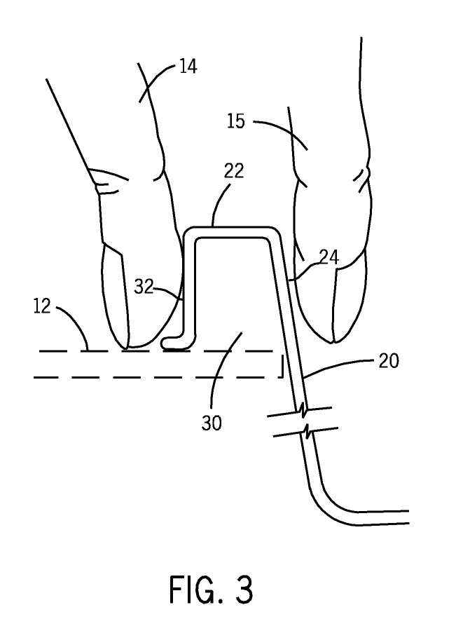

As best shown in FIG. 2, gripping-skirt 32 has a vertical dimension of V which facilitates engagement therewith by the mid-portion of an adult's thumb 14 to raise the pan from the steam-table. FIG. 3 illustrates adult's fingers 14 and 15 pinch-gripping the inner surface of upper portion 21 of surrounding wall 20 and gripping-skirt 32 between his/her thumb 14 and index finger 15. FIG. 2 best shows gripping-skirt 32 configured such that it extends vertically downwardly from lip-portion 22 by a distance V which is greater than a distance H on which lip-portion 22 extends horizontally outwardly from upper edge 21 of surrounding wall 20.

FIGS. 2 and 3 show gripping-skirt 32 being substantially parallel to surrounding wall 20. Gripping-skirt 32 is substantially vertical.

Steam-table pan 10 also includes a bottom-wall 23, bottom corners 29 that are integral with surrounding wall 20 and bottom-wall 23, such bottom-corners 29 being shaped with common partial circular cross-sections with a radius R, as shown in FIG. 2. Surrounding wall 20 includes sidewalls 26 and also side-corners 25 which are integral with adjacent pairs of sidewalls 26, side-corners 25 being shaped with the common partial circular cross-sections with radius R.

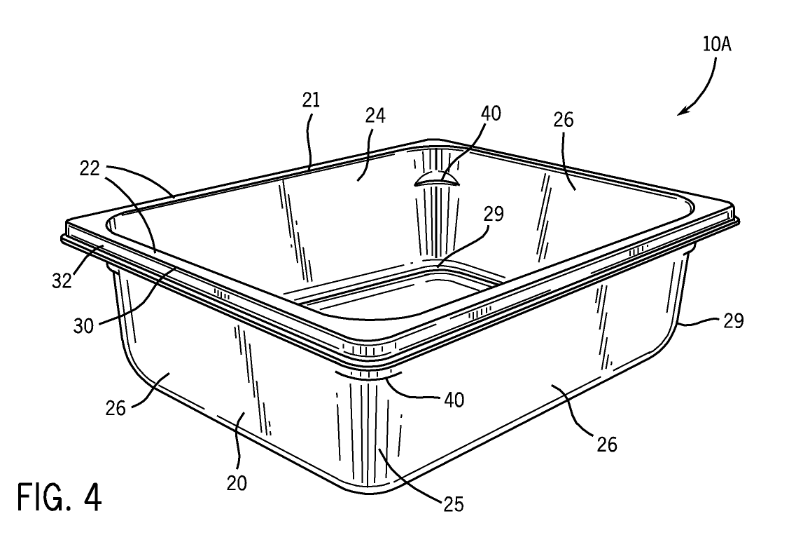

In pan 10A, shown in FIG. 4, surrounding wall 20 includes a plurality of sidewalls 26 extending between corners 25 integral with adjacent sidewalls 26. Surrounding wall 20 further has anti-jam wall-portions 40 to prevent jamming of multiple pans 10A stacked together. As is also seen from FIG. 4, each anti-jam wall-portion 40 is off-planar with respect to its respective sidewall 26.

While the principles of the invention have been shown and described in connection with specific embodiments, it is to be understood that such embodiments are by way of example and are not limiting.

1. In a steam-table pan including (a) a surrounding wall that is dimensioned for insertion in an opening in the top of a steam table and has an upper edge and (b) a lip-portion integral with the upper edge and protruding outwardly therefrom to overlap the steam-table top, the improvement comprising a pinch-gripping bead including an upper portion of the surrounding wall, the lip-portion, and a gripping-skirt which is integral with the lip-portion, extends downwardly therefrom to rest on the steam-table top, and is configured and vertically dimensioned for pinch-gripping of the bead with an adult's fingers to raise the pan from the steam-table.

2. The steam-table pan of claim 1 wherein the gripping-skirt is vertically dimensioned for its engagement by a mid-portion of an adult's thumb to raise the pan from the steam-table.

3. The steam-table pan of claim 1 wherein the gripping-skirt has a vertical dimension of at least about ½ inch.

4. The steam-table pan of claim 1 wherein the gripping-skirt is substantially parallel to the surrounding wall.

5. The steam-table pan of claim 1 wherein the gripping-skirt is substantially vertical.

6. The steam-table pan of claim 1 further including:
a bottom-wall;
bottom corners that are integral with the surrounding wall and the bottom-wall, such bottom-corners being shaped with common partial circular cross-sections;
the surrounding wall having a plurality of sidewalls and side-corners integral with adjacent sidewalls, the side-corners being shaped with the common partial circular cross-sections,
thereby facilitating full engagement of all corners by industry-standard circular-edged utensils.
